(19) United States
(12) Patent Application Publication
(10) Pub. No.: US 2026/0288933 A1
(43) Pub. Date: Sep. 24, 2026

(54) INFORMATION PROCESSING SYSTEM AND METHOD AND NON-TRANSITORY COMPUTER READABLE MEDIUM

(71) Applicant: FUJIFILM Business Innovation Corp., Tokyo (JP)

(72) Inventor: Kota SAKURAI, Kanagawa (JP)

(73) Assignee: FUJIFILM Business Innovation Corp., Tokyo (JP)

(21) Appl. No.: 19/316,247

(22) Filed: Sep. 2, 2025

(30) Foreign Application Priority Data
Mar. 24, 2025 (JP) 2025-048817

(51) Int. Cl. G06F 21/45; G06F 21/34

(52) U.S. Cl. CPC G06F 21/45; G06F 21/34

(57) ABSTRACT

An information processing system includes a processor configured to: obtain device information concerning an authentication device to be used for authenticating a user who has made a request to use the information processing system; and determine whether to use a first authentication method or a second authentication method to authenticate the user with the authentication device in accordance with whether the device information is stored in the information processing system, an authentication strength of the second authentication method being higher than an authentication strength of the first authentication method.

### CROSS-REFERENCE TO RELATED APPLICATIONS

This application is based on and claims priority under 35 USC 119 from Japanese Patent Application No. 2025-048817 filed Mar. 24, 2025.

### BACKGROUND

### i. Technical Field

The present disclosure relates to an information processing system and method and a non-transitory computer readable medium.

### ii. Related Art

Japanese Unexamined Patent Application Publication No. 2006-48487 discloses the following technology. A client PC accesses a server based on the URL of the server read from a card, which stores the URL of the server, authentication information, and card unique information, and sends the authentication information and the card unique information to the server. The server checks the integrity of the authentication information and the card unique information. The client PC performs identity verification by checking the authentication information read from the card against authentication information input by a user.

### SUMMARY

To authenticate a user requesting permission for the use of an information processing system, an authentication device may be used. Hitherto, however, it is not possible to switch the authentication strength used for authentication in accordance with the authentication device.

Aspects of non-limiting embodiments of the present disclosure relate to an information processing system and method that makes it possible to switch the authentication strength in accordance with an authentication device to be used for user authentication.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: obtain device information concerning an authentication device to be used for authenticating a user who has made a request to use the information processing system; and determine whether to use a first authentication method or a second authentication method to authenticate the user with the authentication device in accordance with whether the device information is stored in the information processing system, an authentication strength of the second authentication method being higher than an authentication strength of the first authentication method.

### BRIEF DESCRIPTION OF THE DRAWINGS

An exemplary embodiment of the present disclosure will be described in detail based on the following figures, wherein:

FIG. 1 is a schematic diagram illustrating the configuration of an information processing system utilizing the exemplary embodiment;

FIG. 2 is a block diagram illustrating the configuration of an image processing apparatus;

FIG. 3 is a block diagram illustrating the configuration of an authentication server;

FIG. 4A illustrates an example of information recorded on an IC card, which is used as information for selecting an authentication server;

FIG. 4B illustrates an example of an authentication server list, which is used as information for selecting an authentication server;

FIG. 5 illustrates an example of user information stored in an authentication server;

FIG. 6A illustrates another example of information recorded on an IC card;

FIG. 6B illustrates another example of user information;

FIG. 7 is a flowchart illustrating an operation executed by the image processing apparatus to select the authentication method;

FIG. 8 is a flowchart illustrating an operation executed by a first authentication server when basic authentication is performed;

FIG. 9 is a flowchart illustrating an operation executed by the image processing apparatus when two-step authentication is performed;

FIG. 10 is a flowchart illustrating an operation executed by a second authentication server when two-step authentication is performed;

FIG. 11 is a sequence diagram illustrating a procedure of data exchange between the image processing apparatus and the second authentication server when two-step authentication is performed;

FIG. 12 is a flowchart illustrating an operation executed by the image processing apparatus when starting authentication;

FIG. 13 is a block diagram illustrating the hardware configuration of the image processing apparatus; and

FIG. 14 is a block diagram illustrating the hardware configuration of the authentication server.

### DETAILED DESCRIPTION

An exemplary embodiment of the disclosure will be described below in detail with reference to the accompanying drawings.

### System Configuration

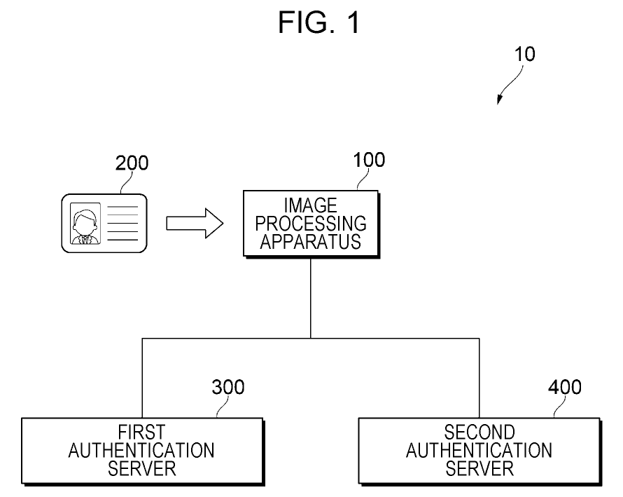

FIG. 1 is a schematic diagram illustrating the configuration of an information processing system 10 utilizing the exemplary embodiment. The information processing system 10 includes an image processing apparatus 100, a first authentication server 300, and a second authentication server 400. The image processing apparatus 100, the first authentication server 300, and the second authentication server 400 are connected to each other via a network. The image processing apparatus 100 performs user authentication by reading an IC card 200 of a user. The image processing apparatus 100 is an example of an information processing apparatus. The network used for connecting these devices is not limited to a particular network if it is a communication network for data communication performed between the devices. Examples of the network are a local area network (LAN), a wide area network (WAN), and the internet. A communication line used for data communication may be a wired medium, a wireless medium, or a combination thereof. A relay device, such as a gateway and a router, may be used to connect the devices via multiple networks and communication lines.

In the information processing system 10 shown in FIG. 1, when using the image processing apparatus 10, a user causes the image processing apparatus 100 to read the IC card 200 to perform user authentication. Based on information read from the IC card 200, the image processing apparatus 100 queries the first authentication server 300 or the second authentication server 400 and performs user authentication. In the information processing system 10, to perform user authentication, different methods: basic authentication and two-step authentication having a higher security can be used. Basic authentication is an example of a first authentication method, and two-step authentication is an example of a second authentication method.

The first authentication server 300 is an authentication server used for performing basic authentication. The second authentication server 400 is an authentication server used for performing two-step authentication. In the following description, the first authentication server 300 and the second authentication server 400 may simply be called the authentication servers 300 and 400 or the authentication servers unless it is necessary to distinguish them from each other. In FIG. 1, only one first authentication server 300 and only one second authentication server 400 are shown. This is merely for showing the roles of the individual authentication servers and are not intended to limit the number of servers in the information processing system 10. In the actual system, multiple first authentication servers and multiple second authentication servers may be provided. Each of the authentication servers 300 and 400 is an example of an authentication device.

In FIG. 1, only one image processing apparatus 100 is shown, but this is not intended to limit the number of image processing apparatuses 100 in the information processing system 10. In the actual system, multiple image processing apparatuses 100 may be provided. If the actual system includes multiple image processing apparatuses 100, there may be a case in which the same server is used as the first authentication server 300 for one image processing apparatus 100 and is used as the second authentication server 400 for another image processing apparatus 100.

The IC card 200 is a card-type recording medium containing an integrated circuit (IC) therein to record information. When performing user authentication, the image processing apparatus 100 uses a physical key. The IC card 200 is an example of the physical key. The IC card 200 may be an authentication card, such as an employee ID card or an admission card, containing an IC therein. On the IC card 200, information used for user authentication is recorded. Details of information recorded on the IC card 200 will be discussed later.

### Configuration of Image Processing Apparatus 100

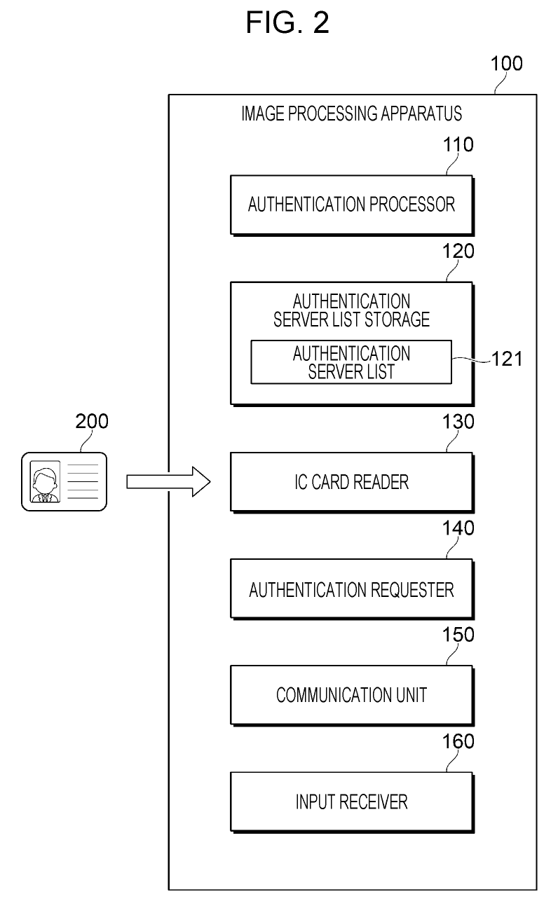

FIG. 2 is a block diagram illustrating the configuration of the image processing apparatus 100. In FIG. 2, the configuration of the image processing apparatus 100 related to authentication processing is shown. The image processing apparatus 100 includes an authentication processor 110, an authentication server list storage 120, an IC card reader 130, an authentication requester 140, a communication unit 150, and an input receiver 160.

The authentication processor 110 executes various operations for user authentication. More specifically, the authentication processor 110 selects the authentication method, obtains authentication results from the first authentication server 300 and the second authentication server 400, and outputs authentication results, for example. When performing user authentication, the authentication processor 110 requests the authentication server list storage 120 to send an authentication server list 121, which will be discussed later. The authentication processor 110 then determines whether to perform basic authentication or two-step authentication, based on the authentication server list 121 obtained from the authentication server list storage 120.

The authentication server list storage 120 stores the authentication server list 121. The authentication server list 121 is a list of servers that can be used to perform basic authentication. Thus, the authentication server list 121 is a list of first authentication servers 300. When the authentication processor 110 performs user authentication, the authentication server list storage 120 sends the authentication server list 121 in response to a request from the authentication processor 110. Details of the authentication server list 121 will be discussed later.

The IC card reader 130 is a reader that reads information recorded on the IC card 200. The IC card reader 130 communicates with the IC of the IC card 200 by short-range wireless communication, such as near field communication (NFC) so as to obtain user authentication information recorded in the IC from the IC card 200.

The authentication requester 140 requests the first authentication server 300 or the second authentication server 400 to execute user authentication in accordance with the determination result made by the authentication processor 110. A request to execute user authentication is sent to the first authentication server 300 or the second authentication server 400 by the communication unit 150 via a network.

The communication unit 150 sends an instruction to the authentication servers 300 and 400 and receives data from the authentication servers 300 and 400. More specifically, the communication unit 150 at least sends a request to execute user authentication made by the authentication requester 140 to the first authentication server 300 or the second authentication server 400 in accordance with the determination result made by the authentication processor 110. The communication unit 150 at least receives user authentication results from the first authentication server 300 or the second authentication server 400. The content of an instruction to be sent and data to be received and the sending/receiving procedure are different depending on whether the communication party is the first authentication server 300 or the second authentication server 400. Details of the procedure of communication between the image processing apparatus 100 and each of the authentication servers 300 and 400 will be discussed later.

The input receiver 160 receives input of an instruction and data sent by a user operation. There may be a case in which the image processing apparatus 100 requests a user to input authentication information, such as a password (PW), when conducting user authentication. In such a case, the input receiver 160 receives input of authentication information sent by a user operation.

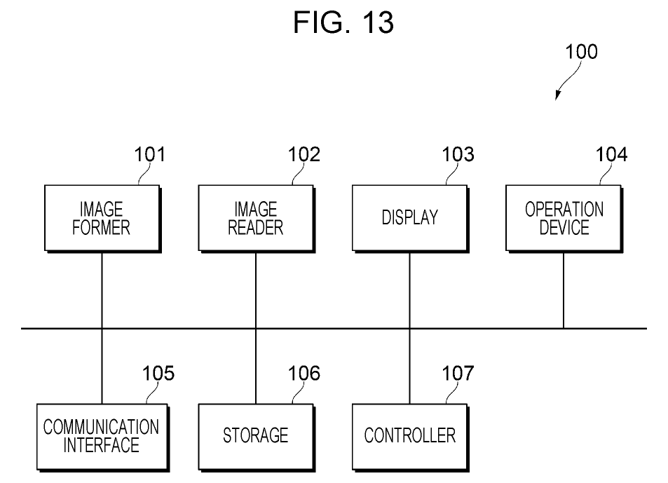

FIG. 13 is a block diagram illustrating the hardware configuration of the image processing apparatus 100. The image processing apparatus 100 includes an image former 101, an image reader 102, a display 103, an operation device 104, a communication interface 105, a storage 106, and a controller 107. The image former 101 forms an image based on image data on a sheet, which is an example of a recording material, by using an image forming material, such as toner or ink. The image reader 102, which is constituted by a scanner, optically reads an image on a document set in the image processing apparatus 100 and generates data on the read image. The display 103 displays various images, such as an information image that can present various items of information to a user, a preview image of an image to be processed, such as an image to be read or output, and an operation image for a user to perform an operation. The display 103 is constituted by a liquid crystal display, for example. The operation device 104 is a device used by a user to input commands and data. The operation device 104 is constituted by a hardware key or a touch sensor that outputs a control signal in accordance with the position pressed or touched by a finger, for example. The communication interface 105 is an interface for sending an instruction to the authentication servers 300 and 400 and receiving data from the authentication servers 300 and 400. The storage 106 stores programs and data executed by the controller 107, log data generated by various operations, such as data on images read by the image reader 102, and various other items of data. The storage 106 is implemented by a storage device, such as a magnetic disk or a solid state drive (SSD). The controller 107 includes a processor, which is a processing unit, and a memory, which is a storage. The controller 107 reads a program stored in the storage 106 into a memory and executes it, thereby controlling the image processing apparatus 100. The image processing apparatus 100 also includes an IC card reader, which is not shown.

The association between the functions of the functional configuration of the image processing apparatus 100 shown in FIG. 2 and the elements of the hardware configuration shown in FIG. 13 is as follows, for example. The functions of the authentication processor 110 and the authentication requester 140 are implemented by the controller 107. The authentication server list storage 120 is implemented by the storage 106. The functions of the IC card reader 130 are implemented by the IC card reader, which is not shown, and the controller 107. The functions of the communication unit 150 are implemented by the communication interface 105 and the controller 107. The functions of the input receiver 160 are implemented by the operation device 104 and the controller 107.

### Configuration of Authentication Servers 300 and 400

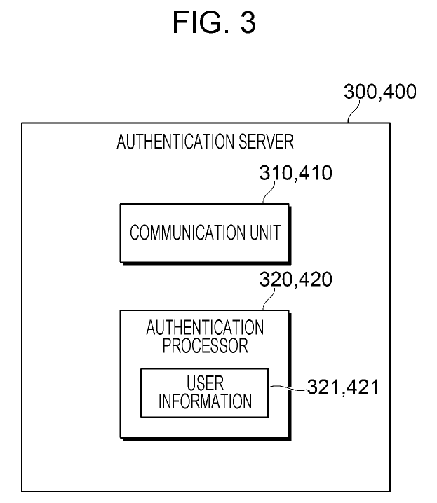

FIG. 3 is a block diagram illustrating the configuration of the authentication servers 300 and 400. The authentication server 300 includes a communication unit 310 and an authentication processor 320. The authentication server 400 includes a communication unit 410 and an authentication processor 420. The authentication processor 320 includes user information 321. The authentication processor 420 includes user information 421.

The communication units 310 and 410 send data to the image processing apparatus 100 and receive an instruction from the image processing apparatus 100. The content of data to be sent to the image processing apparatus 100 and an instruction to be received from the image processing apparatus 100 and the sending/receiving procedure are different depending on whether the first authentication server 300 or the second authentication server 400 is used. Details of the procedure of communication between the image processing apparatus 100 and each of the authentication servers 300 and 400 will be discussed later.

The authentication processors 320 and 420 perform user authentication in response to an authentication request from the image processing apparatus 100. The authentication processor 320 of the first authentication server 300 executes authentication processing of basic authentication, while the authentication processor 420 of the second authentication server 400 executes processing of part of two-step authentication. The user information 321 is used for processing executed by the authentication processor 320, while the user information 421 is used for processing executed by the authentication processor 420. Details of basic authentication and two-step authentication will be discussed later. Details of the user information 321 and the user information 421 will also be discussed later.

### User Authentication

User authentication performed in the information processing system 10 will be discussed below. In the information processing system 10, when a user uses the image processing apparatus 100, user authentication using the authentication server 300 or 400 is performed. As stated above, there are two types of user authentication: basic authentication using the first authentication server 300 and two-step authentication using the second authentication server 400. Regardless of whether basic authentication or two-step authentication is performed, the IC card 200 is used. Whether basic authentication or two-step authentication is performed is determined based on information recorded on the IC card 200 and the authentication server list 121 stored in the image processing apparatus 100.

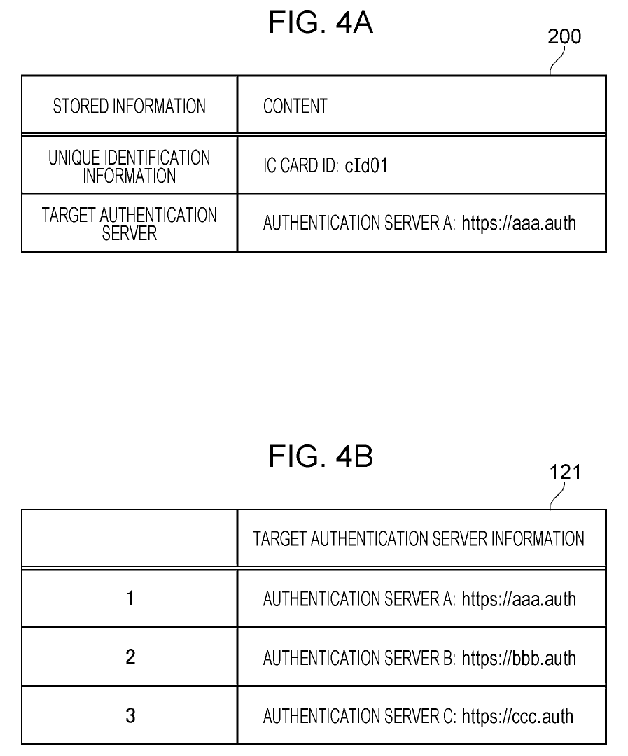

FIGS. 4A and 4B illustrate information for determining whether to use the authentication server 300 or 400. FIG. 4A illustrates an example of information recorded on the IC card 200. FIG. 4B illustrates an example of the authentication server list 121. The authentication processor 110 of the image processing apparatus 100 selects the authentication method, based on information read by the IC card reader 130 from the IC card 200 and the authentication server list 121 stored in the authentication server list storage 120. As one example, when a server recorded in the authentication server list 121 is used as a server for performing user authentication (hereinafter such a server will be called a target authentication server), basic authentication is performed. In other words, the servers recorded in the authentication server list 121 are the first authentication servers 300.

As illustrated in FIG. 4A, "unique identification information" and "target authentication server" are recorded on the IC card 200. The unique identification information is identification information of the IC card 200 (IC card ID). The unique identification information may be regarded as identification information of a user having the IC card 200. In the example in FIG. 4A, as the unique identification information, "IC card ID: cId01" is registered. "Target authentication server" is information for specifying the target authentication server that performs user authentication and is also link information indicating a link to access this target authentication server. As the link information, a uniform resource identifier (URI) is indicated. In the example in FIG. 4A, as "target authentication server", "authentication server A: https://aaa.auth" is recorded. The link information is an example of device information.

As illustrated in FIG. 4B, in the authentication server list 121, identification information of each target authentication server is recorded. In the example in FIG. 4B, link information to access a target authentication server is recorded, together with the identification information of this target authentication server. As the link information, the URI is indicated. As stated above, in this example, the servers recorded in the authentication server list 121 are the first authentication servers 300. In the example in FIG. 4B, three servers: authentication server A, authentication server B, and authentication server C are recorded as the target authentication servers.

The authentication processor 110 of the image processing apparatus 100 checks information of the target authentication server read from the IC card 200 against the authentication server list 121. If the target authentication server represented by the information read from the IC card 200 is included in the authentication server list 121, the authentication processor 110 selects basic authentication to be performed for the user having the IC card 200. If the target authentication server represented by the information read from the IC card 200 is not included in the authentication server list 121, the authentication processor 110 selects two-step authentication to be performed for the user having the IC card 200. In the example in FIGS. 4A and 4B, information of the target authentication server recorded on the IC card 200 is "authentication server A: https://aaa.auth". Authentication server A is included in the authentication server list 121. The authentication processor 110 thus determines that user authentication for the user having the IC card 200 shown in FIG. 4A is performed by basic authentication.

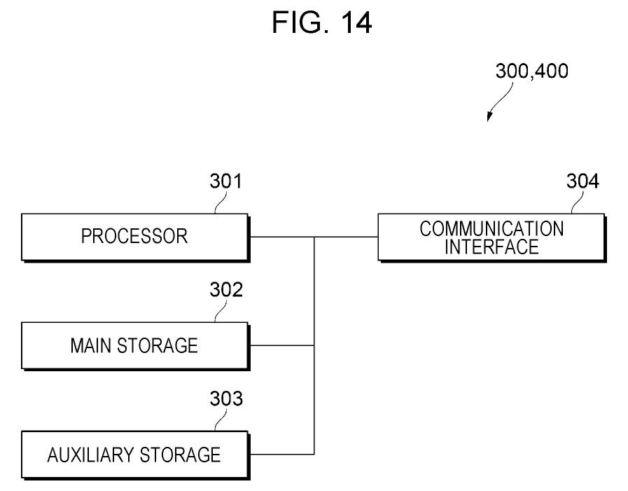

FIG. 14 is a block diagram illustrating the hardware configuration of the authentication servers 300 and 400. The authentication servers 300 and 400 each include a processor 301, a main storage 302, an auxiliary storage 303, and a communication interface 304. The main storage 302 is a work memory used by the processor 301 to execute processing. The auxiliary storage 303 is a storage storing a program executed by the processor 301 and information, such as setting information, used by the processor 301 to execute processing. As the main storage 302, a random access memory (RAM), for example, is used. As the auxiliary storage 303, a magnetic disk or an SSD, for example, is used. The communication interface 304 is an interface for connecting the authentication servers 300 and 400 to the image processing apparatus 100.

The association between the functions of the functional configuration of the authentication servers 300 and 400 shown in FIG. 3 and the elements of the hardware configuration shown in FIG. 14 is as follows, for example. The communication units 310 and 410 are implemented by the processor 301 and the communication interface 304. The authentication processors 320 and 420 are implemented by the processor 301, the main storage 302, and the auxiliary storage 303.

### User Information of Authentication Servers 300 and 400

The user information 321 stored in the authentication processor 320 of the authentication server 300 and the user information 421 stored in the authentication processor 420 of the authentication server 400 will now be explained below. In each of the user information 321 and the user information 421, information concerning users who can use the corresponding authentication server as the target authentication server is recorded. Whether a server performing user authentication is used as the first authentication server 300 or the second authentication server 400 is determined in accordance with whether this server is registered in the authentication server list 121 of the image processing apparatus 100. There may be a case in which, while a server serves as the first authentication server 300 for a certain image processing apparatus 100, this server serves as the second authentication server 400 for another image processing apparatus 100. Hence, items of information recorded in the user information 321 and those in the user information 421 are similar to each other.

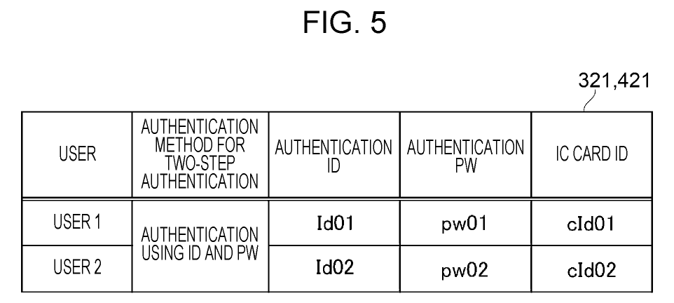

FIG. 5 illustrates an example of the user information 321 or 421 of the authentication server 300 or 400. In the user information 321 or 421, "user", "authentication method for two-step authentication", "authentication ID", "authentication PW", and "IC card ID" are recorded. "User" is identification information of a user using the first authentication server 300. Information registered in "user" may be the name of a user (registered name). In the example in FIG. 5, user 1 and user 2 are registered in the user information 321 or 421. It is now assumed that the authentication server 300 storing the user information 321 or the authentication server 400 storing the user information 421 is authentication server A.

"Authentication method for two-step authentication" indicates the authentication method used in two-step authentication when the authentication server 300 or 400 is used as the second authentication server 400. In the example in FIG. 5, for both of user 1 and user 2, authentication using the user ID ("ID" in FIG. 5) and the password ("PW" in FIG. 5) is performed. In the example in FIG. 5, in the case of two-step authentication, the same authentication method is used for user 1 and user 2. However, different authentication methods may be used among individual users.

"Authentication ID" is the authentication user ID used in two-step authentication. "Authentication PW" is the authentication password used in two-step authentication. If the authentication method other than that using the user ID and the password is indicated in "authentication method for two-step authentication", authentication information to be used for the indicated authentication method is registered in the user information 321 or 421, in addition to or instead of "authentication ID" and "authentication PW".

"IC card ID" is unique identification information recorded on the IC card 200 of "user". If the unique identification information read from the IC card 200 of the user is registered in "IC card ID" of the user information 321 or 421, the authentication server 300 or 400 executes processing for authenticating this user. Information of "IC card ID" is used for both of basic authentication and two-step authentication.

The above-described explanation will be paraphrased with reference to FIGS. 4A, 4B, and 5. FIGS. 4A and 4B show that information of the target authentication server recorded on the IC card 200 is "authentication server A: https://aaa.auth" and this target authentication server is registered in the authentication server list 121 of the image processing apparatus 100. In this case, basic authentication is selected as the authentication method. Authentication server A, which is the target authentication server, thus serves as the first authentication server 300.

FIG. 4A shows that the unique identification information recorded on the IC card 200 is "IC card ID: cId01". This unique identification information is registered as the IC card ID of user 1 in the user information 321 of authentication server A, as shown in FIG. 5. Authentication server A, which is the first authentication server 300, thus authenticates user 1.

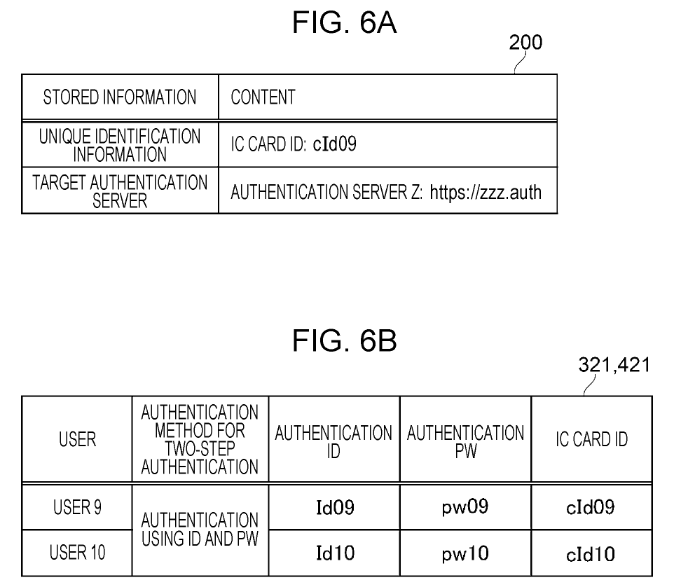

FIG. 6A illustrates another example of information recorded on the IC card 200. FIG. 6B illustrates another example of user information 321 or 421. It is assumed that the authentication server 300 storing the user information 321 shown in FIG. 6B or the authentication server 400 storing the user information 421 shown in FIG. 6B is authentication server Z.

In this example, as illustrated in FIG. 6A, "IC card ID: cId09" is recorded as the unique identification information of the IC card 200, and "authentication server Z: https://zzz.auth" is recorded as the target authentication server. As illustrated in FIG. 6B, in the user information 321 or 421 stored in authentication server Z, information of user 9 and information of user 10 are registered. The authentication server list 121 similar to that in FIG. 4B is stored in the image processing apparatus 100, though it is not shown. That is, in the authentication server list 121, three servers: authentication server A, authentication server B, and authentication server C are recorded as the target authentication servers.

The above-described explanation will be paraphrased with reference to FIGS. 4B, 6A, and 6B. FIG. 6A shows that information of the target authentication server recorded on the IC card 200 is "authentication server Z: https://zzz.auth". This target authentication server is not registered in the authentication server list 121 of the image processing apparatus 100, as shown in FIG. 4B. In this case, two-step authentication is selected as the authentication method. Authentication server Z, which is the target authentication server performing two-step authentication, thus serves as the second authentication server 400.

The unique identification information recorded on the IC card 200 is "IC card ID: cId09". This unique identification information is registered in the user information 421 of authentication server Z as the IC card ID of user 9. Authentication server Z, which is the second authentication server 400, thus authenticates user 9. More specifically, authentication server Z performs two-step authentication by using the authentication ID and the authentication password (WD).

### Procedure of User Authentication

The procedure for user authentication executed in the information processing system 10 will now be described below. In the information processing system 10, the image processing apparatus 100 first determines the authentication method in accordance with the target authentication server. Then, in accordance with the determined authentication method, basic authentication is executed by the first authentication server 300 or two-step authentication is executed by the second authentication server 400.

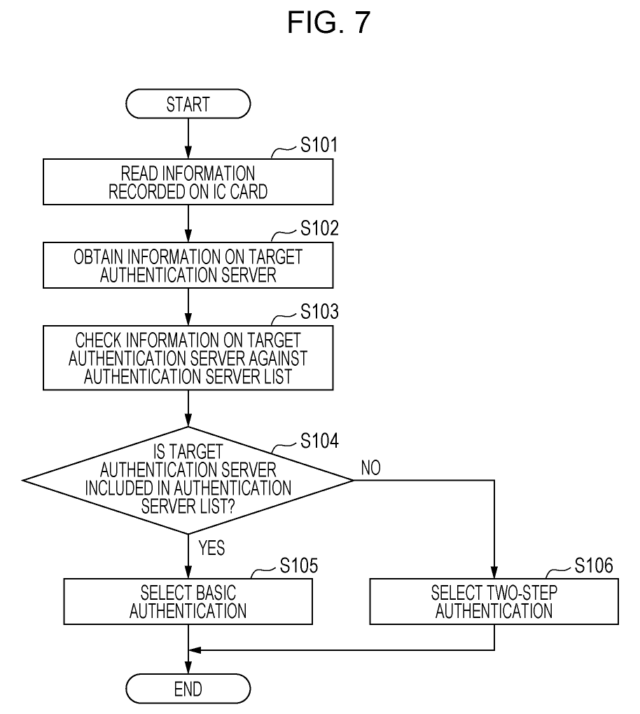

FIG. 7 is a flowchart illustrating an operation executed by the image processing apparatus 100 to select the authentication method. When performing user authentication for using the image processing apparatus 100, a user causes the image processing apparatus 100 to read information recorded on the IC card 200. In step S101, the IC card reader 130 of the image processing apparatus 100 reads information recorded on the IC card 200. In step S102, the IC card reader 130 obtains information on the target authentication server from the IC card 200. In step S103, the authentication processor 110 of the image processing apparatus 100 checks the obtained information on the target authentication server against the authentication server list 121 stored in the authentication server list storage 120.

It is then determined in step S104 whether the target authentication server represented by the information obtained from the IC card 200 is included in the authentication server list 121. If the target authentication server is included in the authentication server list 121 (YES in step S104), the authentication processor 110 determines in step S105 that basic authentication is used for performing user authentication. In this case, the authentication requester 140 of the image processing apparatus 100 requests the target authentication server, which serves as the first authentication server 300, to perform user authentication using basic authentication.

If the target authentication server represented by the information obtained from the IC card 200 is not included in the authentication server list 121 (NO in step S104), the authentication processor 110 determines in step S106 that two-step authentication is used for performing user authentication. In this case, the authentication requester 140 requests the target authentication server, which serves as the second authentication server 400, to perform user authentication using two-step authentication.

The above-described processing will be paraphrased with reference to FIGS. 4A-6B. As shown in FIG. 4B, in the authentication server list 121, authentication server A, authentication server B, and authentication server C are registered as the target authentication servers. As shown in FIG. 4A, in the IC card 200 of user 1, authentication server A is registered as the target authentication server. FIG. 4B shows that authentication server A is registered in the authentication server list 121. Hence, basic authentication is selected as the authentication method for user 1. In contrast, as shown in FIG. 6A, authentication server Z is registered as the target authentication server on the IC card 200 of user 9. As shown in FIG. 4B, authentication server Z is not registered in the authentication server list 121. Hence, two-step authentication is selected as the authentication method for user 9.

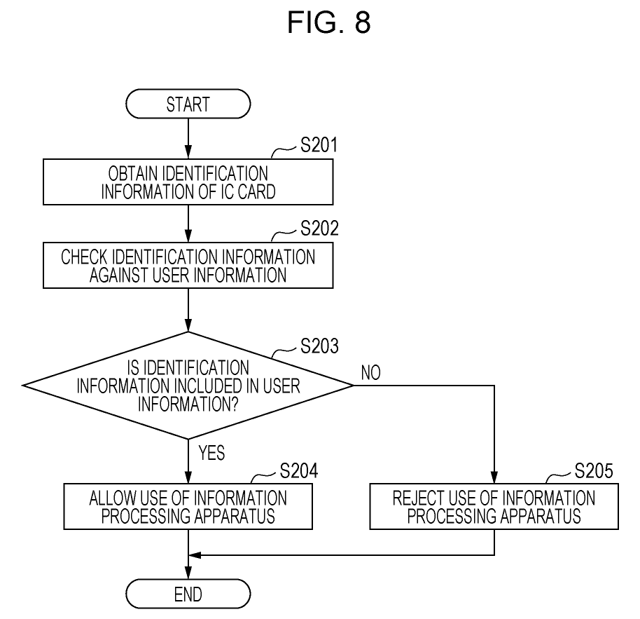

FIG. 8 is a flowchart illustrating an operation executed by the first authentication server 300 when basic authentication is performed. When basic authentication is selected, the authentication requester 140 of the image processing apparatus 100 sends unique identification information read from the IC card 200 to the target authentication server, together with a request to perform user authentication using basic authentication. Upon receiving a request to perform basic authentication from the image processing apparatus 100, in step S201, the first authentication server 300 obtains the unique identification information read from the IC card 200 and sent with the request. Then, in step S202, the authentication processor 320 of the first authentication server 300 checks the obtained unique identification information against the user information 321.

It is then determined in step S203 whether the unique identification information obtained from the image processing apparatus 100 is included in the user information 321. If the unique identification information is included in the user information 321 (YES in step S203), the authentication processor 320 determines that authentication has succeeded and allows the use of the image processing apparatus 100 in step S204. Then, as the authentication result, the first authentication server 300 notifies the image processing apparatus 100 that the use of the image processing apparatus 100 is allowed.

If the unique identification information obtained from the image processing apparatus 100 is not included in the user information 321 (NO in step S203), the authentication processor 320 determines that authentication has failed and rejects the use of the image processing apparatus 100 in step S205. Then, as the authentication result, the first authentication server 300 notifies the image processing apparatus 100 that the use of the image processing apparatus 100 is rejected.

If, as the basic authentication result, the image processing apparatus 100 has received from the first authentication server 300 notification indicating that the use of the image processing apparatus 100 is allowed, it is ready to receive an operation for image processing from the user. In contrast, if, as the basic authentication result, the image processing apparatus 100 has received from the first authentication server 300 notification indicating that the use of the image processing apparatus 100 is rejected, it enters a state not to accept any operation for image processing from the user.

The above-described processing will be paraphrased with reference to FIGS. 4A-5. The unique identification information read from the IC card 200 shown in FIG. 4A matches the IC card ID of user 1 indicated by the user information 321 shown in FIG. 5 in authentication server A, which serves as the first authentication server 300. The authentication processor 320 thus determines that user authentication using basic authentication has succeeded.

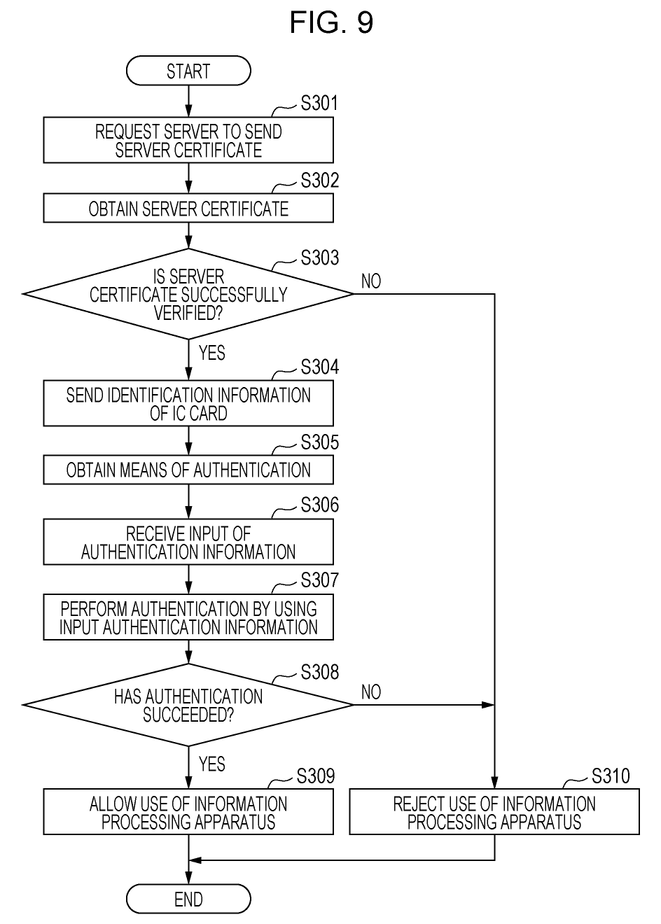

FIG. 9 is a flowchart illustrating an operation executed by the image processing apparatus 100 when two-step authentication is performed. When two-step authentication is selected, by using information on the target authentication server read from the IC card 200, the authentication requester 140 of the image processing apparatus 100 requests the target authentication server to send a server certificate in step S301. The server certificate is a digital certificate that is used to encrypt communication with a server and to prove the authenticity of an operator or an organization of a website operated by this server. The server certificate is also called a SSL (Secure Sockets Layer) server certificate or a SSL/TLS (Transport Layer Security) server certificate.

In step S302, the authentication requester 140 of the image processing apparatus 100 obtains a server certificate from the target authentication server. The authentication requester 140 verifies the obtained server certificate. If the server certificate is successfully verified (YES in step S303), the authentication requester 140 sends the unique identification information read from the IC card 200 to the target authentication server, together with a request to perform user authentication, in step S304. This enables the second authentication server 400, which is the target authentication server, to perform the first step of two-step authentication. Authentication processing executed by the second authentication server 400 in the first step of two-step authentication is similar to that of basic authentication discussed with reference to FIG. 7.

After the first step of two-step authentication performed by the second authentication server 400 has succeeded, the second authentication server 400 notifies the image processing apparatus 100 of a means of authentication to be used for the second step of two-step authentication. In this example, inputting authentication information via a user operation is used as the means of authentication for the second step of two-step authentication. The authentication information is the user ID and the password, for example. When notifying the image processing apparatus 100 of the means of authentication, the second authentication server 400 also sends authentication information (user ID and password, for example) based on the means of authentication to the image processing apparatus 100.

In step S305, the image processing apparatus 100 obtains the means of authentication and then performs the second step of two-step authentication based on the means of authentication. In this example, the means of authentication used for the second step of two-step authentication is inputting of authentication information via a user operation. The image processing apparatus 100 thus receives input of authentication information from the input receiver 160 via a user operation in step S306. In step S307, the authentication processor 110 executes authentication processing by using the authentication information received from the second authentication server 400 and the authentication information input in step S306. More specifically, the authentication processor 110 determines whether the authentication information obtained from the second authentication server 400 and the authentication information input in step S306 match each other. If the two items of authentication information match each other, the authentication processor 110 determines that authentication has succeeded. If the two items of authentication information do not match each other, the authentication processor 110 determines that authentication has failed.

If authentication has succeeded (YES in step S308), the authentication processor 110 allows the user to use the image processing apparatus 100 in step S309. The image processing apparatus 100 is then ready to receive an operation for image processing from the user. If authentication has failed (NO in step S308), the authentication processor 110 rejects the use of the image processing apparatus 100 for the user in step S310. The image processing apparatus 100 enters a state not to accept any operation for image processing from the user.

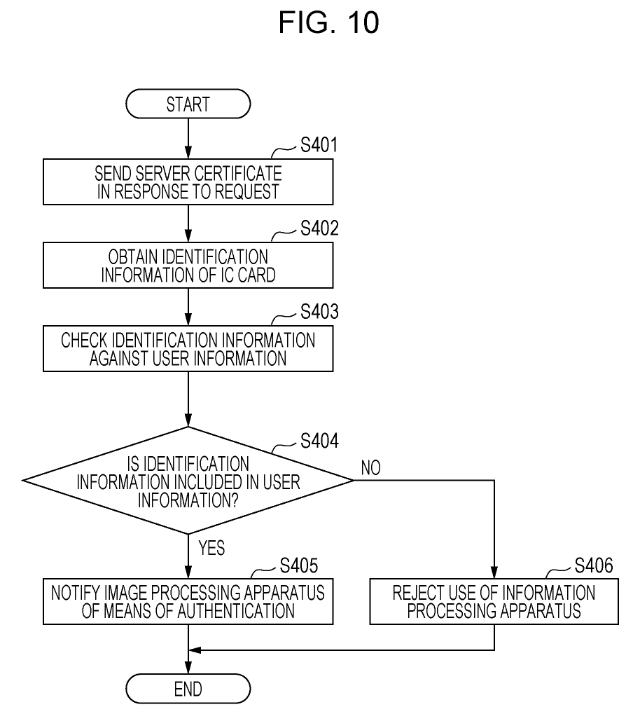

FIG. 10 is a flowchart illustrating an operation executed by the second authentication server 400 when two-step authentication is performed. When the target authentication server read from the IC card 200 of the user is not registered in the authentication server list 121 of the image processing apparatus 100, this target authentication server is used as the second authentication server 400. Upon receiving a request for a server certificate from the image processing apparatus 100, the second authentication server 400 sends a server certificate to the image processing apparatus 100 in response to this request in step S401. The image processing apparatus 100 verifies the server certificate obtained from the second authentication server 400. If the server certificate is successfully verified, the image processing apparatus 100 requests the second authentication server 400 to perform user authentication.

In step S402, the second authentication server 400 receives unique identification information read from the IC card 200 from the image processing apparatus 100, together with a request to perform user authentication. Then, in step S403, the authentication processor 420 of the second authentication server 400 checks the obtained unique identification information against the user information 421.

The second authentication server 400 then determines in step S404 whether the unique identification information obtained from the image processing apparatus 100 is included in the user information 421. If the unique identification information is included in the user information 421 (YES in step S404), the authentication processor 420 of the second authentication server 400 determines that the first step of two-step authentication has succeeded. Then, in step S405, the authentication processor 420 notifies the image processing apparatus 100 of the means of authentication to be used for the second step of two-step authentication. If the second step of two-step authentication is performed by using the user ID and the password, the authentication processor 420 sends the user ID and the password registered in the user information 421 to the image processing apparatus 100. After obtaining the means of authentication for the second step of two-step authentication, the image processing apparatus 100 executes authentication processing for the second step of two-step authentication based on the means of authentication, as discussed with reference to FIG. 9.

If the unique identification information obtained from the image processing apparatus 100 is not included in the user information 421 (NO in step S404), the authentication processor 420 of the second authentication server 400 determines that the first step of two-step authentication has failed. Then, in step S406, the authentication processor 420 rejects the use of the image processing apparatus 100 for the user in the first step of two-step authentication. The second authentication server 400 then notifies the image processing apparatus 100, as the authentication result, that the use of the image processing apparatus 100 is rejected.

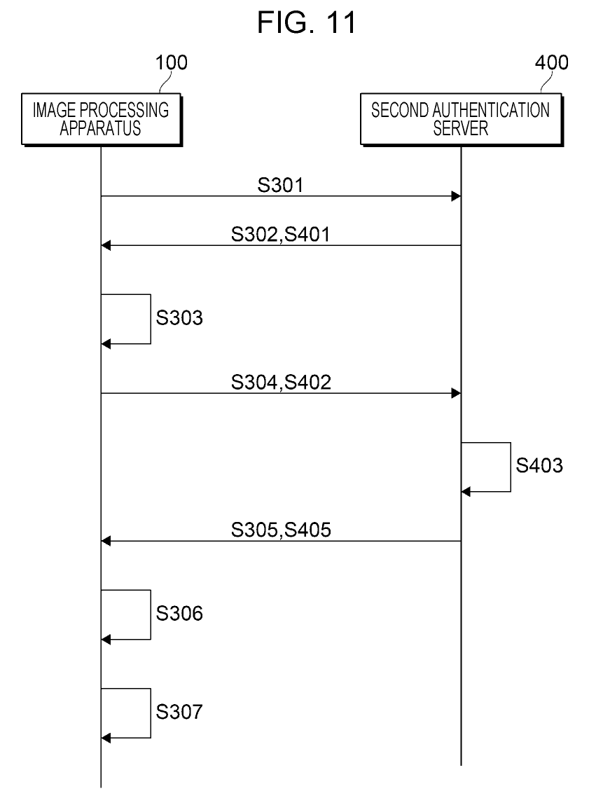

FIG. 11 is a sequence diagram illustrating a procedure of data exchange between the image processing apparatus 100 and the second authentication server 400 when two-step authentication is performed. The step numbers indicated in FIG. 11 correspond to those in FIGS. 9 and 10. As illustrated in FIG. 11, when two-step authentication is performed, the image processing apparatus 100 requests the second authentication server 400 to send a server certificate (S301). The second authentication server 400 sends a server certificate in response to a request (S401), and the image processing apparatus 100 receives the server certificate (S302). Then, the image processing apparatus 100 verifies the obtained server certificate (S303).

Then, the image processing apparatus 100 sends unique identification information read from the IC card 200 to the target authentication server (S304), and the second authentication server 400 obtains this unique identification information (S402). The second authentication server 400 executes the first step of two-step authentication, based on the unique identification information (S403).

After the first step of two-step authentication has succeeded, the second authentication server 400 sends a means of authentication for the second step of two-step authentication to the image processing apparatus 100 (S405), and the image processing apparatus 100 obtains this means of authentication (S305). Then, the image processing apparatus 100 receives input of authentication information from the user (S306) and executes the second step of two-step authentication based on the means of authentication and the input authentication information (S307).

The above-described processing will be paraphrased with reference to FIGS. 6A and 6B. The unique identification information read from the IC card 200 (see FIG. 6A) matches the IC card ID of user 9 registered in the user information 421 (see FIG. 6B) of authentication server Z, which serves as the second authentication server 400. It is thus determined that the first step of two-step authentication has succeeded and the second step of two-step authentication is started.

The user information 421 in FIG. 6B shows that the authentication method used for two-step authentication is performed by using the user ID and the password. Authentication server Z thus sends the authentication ID "Id09" and the authentication PW "pw09" to the image processing apparatus 100 as authentication information used for the means of authentication for user 9. The image processing apparatus 100 receives input of the user ID and the password from user 9 and checks the input user ID and password against the authentication ID and the authentication PW obtained from authentication server Z. The two user IDs match each other and the two passwords also match each other. It is thus determined that the second step of two-step authentication has also succeeded.

### Modified Examples

As described above, in the information processing system 10 according to the exemplary embodiment, information recorded on the IC card 200, which serves as a physical key, is used, and the authentication method is determined in accordance with the authentication server indicated by this information. With this configuration, the information processing system 10 is able to switch the authentication strength in accordance with the authentication server indicated by information recorded on the IC card 200. In some cases, it may be desirable to avoid the use of a certain authentication server or to set a condition to use a certain authentication server. For such authentication servers, a list may be created separately from the authentication server list 121 and may be used when a target authentication server is specified.

In one example, there may be a case in which the authentication server indicated in the IC card 200 is not suitable for some reason, such as in terms of security requirements, and the use of this server is to be avoided. In this case, if authentication servers to be avoided are identified beforehand, a list of such authentication servers (hereinafter called "to-be-rejected server list") may be created and stored, and information recorded on the IC card 200 may be checked against the to-be-rejected server list. More specifically, upon obtaining information recorded on the IC card 200, the image processing apparatus 100 first checks the information of the target authentication server against the to-be-rejected server list. If the target authentication server is recorded in the to-be-rejected server list, the image processing apparatus 100 does not perform authentication and rejects the use of the image processing apparatus 100 by a user. In this example, it is not possible to use the servers registered in the to-be-rejected server list as the authentication servers 300 and 400 in the information processing system 10.

In another example, there may be a case in which the use of the image processing apparatus 100 is charged. In this case, an authentication server executes charging processing. The target authentication server thus needs to be a server that can execute charging processing. If authentication servers that can execute charging processing are identified beforehand, a list of such servers (hereinafter called the charging server list) may be created and stored, and information recorded on the IC card 200 may be checked against the charging server list. More specifically, upon obtaining information recorded on the IC card 200, the image processing apparatus 100 first checks the information of the target authentication server against the charging server list. If the target authentication server is not included in the charging server list, the image processing apparatus 100 does not perform authentication and rejects the use of the image processing apparatus 100 by a user. In this example, it is not possible to use servers that are not registered in the charging server list as the authentication servers 300 and 400 in the information processing system 10.

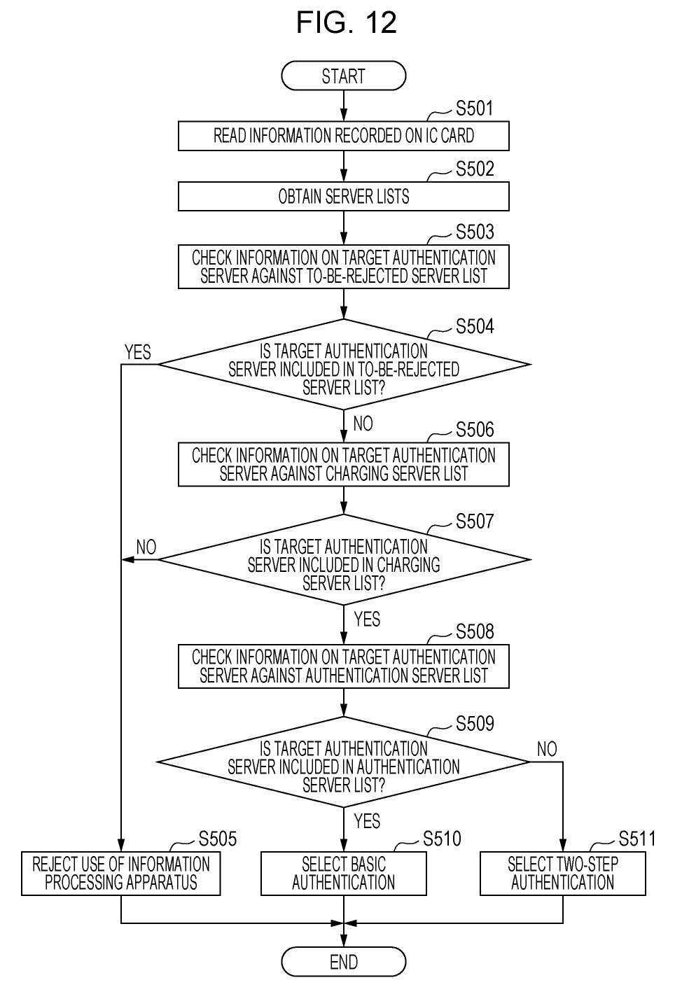

FIG. 12 is a flowchart illustrating an operation executed by the image processing apparatus 100 when starting authentication. FIG. 12 shows an example of the operation of the image processing apparatus 100 when both of the to-be-rejected server list and the charging server list are set in the above-described modified example. Each of the to-be-rejected server list and the charging server list is an example of a first type of device information. In this modified example, the authentication server list 121 is a second type of device information.

When performing user authentication for the use of the image processing apparatus 100, a user causes the image processing apparatus 100 to read information recorded on the IC card 200. In step S501, the IC card reader 130 of the image processing apparatus 100 reads the information on the IC card 200 and obtains information of the target authentication server. In step S502, the authentication processor 110 of the image processing apparatus 100 reads various server lists from the storage. In this example, the authentication processor 110 reads the to-be-rejected server list and the charging server list, together with the authentication server list 121.

In step S503, the authentication processor 110 checks information on the target authentication server read from the IC card 200 against the to-be-rejected server list and determines in step S504 whether information on the target authentication server is registered in the to-be-rejected server list. If the information on the target authentication server is registered in the to-be-rejected server list (YES in step S504), the authentication processor 110 does not execute authentication processing and rejects the use of the image processing apparatus 100 by the user in step S505. The image processing apparatus 100 enters a state not to accept any operation for image processing from the user.

If the information on the target authentication server is not registered in the to-be-rejected server list (NO in step S504), the authentication processor 110 checks information on the target authentication server obtained from the IC card 200 against the charging server list in step S506 and determines in step S507 whether information on the target authentication server is registered in the charging server list. If the information on the target authentication server is not registered in the charging server list (NO in step S507), the authentication processor 110 does not execute authentication processing and rejects the use of the image processing apparatus 100 by the user in step S505. The image processing apparatus 100 enters a state not to accept any operation for image processing by the user.

If the information on the target authentication server is registered in the charging server list (YES in step S507), the authentication processor 110 checks the information on the target authentication server obtained from the IC card 200 against the authentication server list 121 in step S508 and determines in step S509 whether the information on the target authentication server is included in the authentication server list 121.

If the information on the target authentication server is included in the authentication server list 121 (YES in step S509), the authentication processor 110 determines in step S510 that basic authentication is used for performing user authentication. In this case, the authentication requester 140 of the image processing apparatus 100 requests the target authentication server, which serves as the first authentication server 300, to perform user authentication using basic authentication.

If the information on the target authentication server is not included in the authentication server list 121 (NO in step S509), the authentication processor 110 determines in step S511 that two-step authentication is used for performing user authentication. In this case, the authentication requester 140 requests the target authentication server, which serves as the second authentication server 400, to perform user authentication using two-step authentication.

The exemplary embodiment of the disclosure has been discussed above. Nevertheless, this is not intended to limit the technical scope of the disclosure to this exemplary embodiment. For example, in the above-described exemplary embodiment, the IC card 200 is used as a physical key. However, the IC card 200 or the IC contained therein is only an example of the physical key, and another type of recording medium, such as magnetic tape or a medium other than a card type medium, may be used.

The authentication server list 121 stored in the server list storage 120 of the image processing apparatus 100 is a list of authentication servers used as the first authentication servers 300 when basic authentication is performed. Alternatively, the authentication server list 121 may be a list of authentication servers used as the second authentication servers 400 when two-step authentication is performed. The authentication server list 121 may be a list of authentication servers serving as the first authentication servers 300 and those serving as the second authentication servers 400 that are separately registered.

In the above-described exemplary embodiment, an authentication server can be used as either one of the first authentication server 300 and the second authentication server 400 in accordance with the content of the authentication server list 121 of the image processing apparatus 100. In contrast, among the authentication servers, some authentication servers may be used as dedicated servers only as the first authentication server 300, while some authentication servers may be used as dedicated servers only as the second authentication server 400.

The above-described exemplary embodiment has been discussed through user authentication of a user using the image processing apparatus 100. However, the exemplary embodiment may be applied to various information processing apparatuses other than the image processing apparatus 100 as a user authentication system. Various other modifications and alternatives for the configuration of the exemplary embodiment may be made without departing from the technical scope of the disclosure and they are encompassed in the disclosure. The disclosure may also be applicable to a program and a program product.

The controller 107 of the image processing apparatus 100 and the authentication servers 300 and 400 are implemented by a computer. The authentication servers 300 and 400 may be computer devices connected to a network or virtual servers constituted by a combination of computer resources in a network.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system comprising:
a processor configured to:
   obtain device information concerning an authentication device to be used for authenticating a user who has made a request to use the information processing system; and
   determine whether to use a first authentication method or a second authentication method to authenticate the user with the authentication device in accordance with whether the device information is stored in the information processing system, an authentication strength of the second authentication method being higher than an authentication strength of the first authentication method.

(((2)))

The information processing system according to (((1))), wherein the processor is configured to:
authenticate the user with the authentication device by using the first authentication method if the device information is stored in the information processing system; and
authenticate the user with the authentication device by using the second authentication method if the device information is not stored in the information processing system.

(((3)))

The information processing system according to (((1))) or (((2))), wherein the processor is configured to:
authenticate the user with the authentication device by using the first authentication method if the device information is not stored in the information processing system; and
authenticate the user with the authentication device by using the second authentication method if the device information is stored in the information processing system.

(((4)))

The information processing system according to one of (((1))) to (((3))), wherein:
the first authentication method is an authentication method executing first authentication processing; and
the second authentication method is an authentication method executing second authentication processing as well as the first authentication processing.

(((5)))

The information processing system according to (((4))), wherein the processor is configured to:
also obtain medium information concerning a medium owned by the user,
wherein the first authentication processing is authentication processing based on the medium information, and
wherein the second authentication processing is authentication processing based on information which is obtained separately from the medium information.

(((6)))

The information processing system according to one of (((1))) to (((5))), wherein the processor is configured to determine whether to authenticate the user with the authentication device and whether to use the first authentication method or the second authentication method to authenticate the user with the authentication device, in accordance with as what type of device information the device information is stored in the information processing system.

(((7)))

The information processing system according to (((6))), wherein the processor is configured to:
determine not to authenticate the user with the authentication device if the device information is stored in the information processing system as a first type of device information; and
determine, if the device information is not stored in the information processing system as the first type of device information, whether to use the first authentication method or the second authentication method to authenticate the user with the authentication device in accordance with whether the device information is stored in the information processing system as a second type of device information.

(((8)))

The information processing system according to (((6))), wherein the processor is configured to:
determine not to authenticate the user with the authentication device if the device information is not stored in the information processing system as a first type of device information; and
determine, if the device information is stored in the information processing system as the first type of device information, whether to use the first authentication method or the second authentication method to authenticate the user with the authentication device in accordance with whether the device information is stored in the information processing system as a second type of device information.

(((9)))

The information processing system according to (((7))) or (((8))), wherein:
the first type of device information is information concerning an authentication device which is determined to be the first type of device based on a predetermined standard; and
the second type of device information is information concerning an authentication device that authenticates the user by using the first authentication method or the second authentication method.

(((10)))

The information processing system according to (((9))), wherein the predetermined standard is a standard regarding security requirements.

(((11)))

The information processing system according to (((9))), wherein the predetermined standard is a standard regarding charging for using the information processing system.

(((12)))

A program causing a computer to execute:
a function of obtaining device information concerning an authentication device to be used for authenticating a user who has made a request to use the information processing system; and
a function of determining whether to use a first authentication method or a second authentication method to authenticate the user with the authentication device in accordance with whether the device information is stored in the information processing system, an authentication strength of the second authentication method being higher than an authentication strength of the first authentication method.

What is claimed is:

1. An information processing system comprising:
a processor configured to:
obtain device information concerning an authentication device to be used for authenticating a user who has made a request to use the information processing system; and
determine whether to use a first authentication method or a second authentication method to authenticate the user with the authentication device in accordance with whether the device information is stored in the information processing system, an authentication strength of the second authentication method being higher than an authentication strength of the first authentication method.

2. The information processing system according to claim 1, wherein the processor is configured to:
authenticate the user with the authentication device by using the first authentication method if the device information is stored in the information processing system; and
authenticate the user with the authentication device by using the second authentication method if the device information is not stored in the information processing system.

3. The information processing system according to claim 1, wherein the processor is configured to:
authenticate the user with the authentication device by using the first authentication method if the device information is not stored in the information processing system; and
authenticate the user with the authentication device by using the second authentication method if the device information is stored in the information processing system.

4. The information processing system according to claim 2, wherein:
the first authentication method is an authentication method executing first authentication processing; and
the second authentication method is an authentication method executing second authentication processing as well as the first authentication processing.

5. The information processing system according to claim 3, wherein:
the first authentication method is an authentication method executing first authentication processing; and
the second authentication method is an authentication method executing second authentication processing as well as the first authentication processing.

6. The information processing system according to claim 4, wherein the processor is configured to:
also obtain medium information concerning a medium owned by the user,
wherein the first authentication processing is authentication processing based on the medium information, and
wherein the second authentication processing is authentication processing based on information which is obtained separately from the medium information.

7. The information processing system according to claim 5, wherein the processor is configured to:
also obtain medium information concerning a medium owned by the user,
wherein the first authentication processing is authentication processing based on the medium information, and
wherein the second authentication processing is authentication processing based on information which is obtained separately from the medium information.

8. The information processing system according to claim 1, wherein the processor is configured to determine whether to authenticate the user with the authentication device and whether to use the first authentication method or the second authentication method to authenticate the user with the authentication device, in accordance with as what type of device information the device information is stored in the information processing system.

9. The information processing system according to claim 8, wherein the processor is configured to:
determine not to authenticate the user with the authentication device if the device information is stored in the information processing system as a first type of device information; and
determine, if the device information is not stored in the information processing system as the first type of device information, whether to use the first authentication method or the second authentication method to authenticate the user with the authentication device in accordance with whether the device information is stored in the information processing system as a second type of device information.

10. The information processing system according to claim 8, wherein the processor is configured to:
determine not to authenticate the user with the authentication device if the device information is not stored in the information processing system as a first type of device information; and
determine, if the device information is stored in the information processing system as the first type of device information, whether to use the first authentication method or the second authentication method to authenticate the user with the authentication device in accordance with whether the device information is stored in the information processing system as a second type of device information.

11. The information processing system according to claim 9, wherein:
the first type of device information is information concerning an authentication device which is determined to be the first type of device based on a predetermined standard; and
the second type of device information is information concerning an authentication device that authenticates the user by using the first authentication method or the second authentication method.

12. The information processing system according to claim 10, wherein:
the first type of device information is information concerning an authentication device which is determined to be the first type of device based on a predetermined standard; and
the second type of device information is information concerning an authentication device that authenticates the user by using the first authentication method or the second authentication method.

13. The information processing system according to claim 11, wherein the predetermined standard is a standard regarding security requirements.

14. The information processing system according to claim 12, wherein the predetermined standard is a standard regarding security requirements.

15. The information processing system according to claim 11, wherein the predetermined standard is a standard regarding charging for using the information processing system.

16. The information processing system according to claim 12, wherein the predetermined standard is a standard regarding charging for using the information processing system.

17. An information processing method comprising:
obtaining device information concerning an authentication device to be used for authenticating a user who has made a request to use the information processing system; and
determining whether to use a first authentication method or a second authentication method to authenticate the user with the authentication device in accordance with whether the device information is stored in the information processing system, an authentication strength of the second authentication method being higher than an authentication strength of the first authentication method.

18. A non-transitory computer readable medium storing a program causing a computer to execute a process, the process comprising:
obtaining device information concerning an authentication device to be used for authenticating a user who has made a request to use the information processing system; and
determining whether to use a first authentication method or a second authentication method to authenticate the user with the authentication device in accordance with whether the device information is stored in the information processing system, an authentication strength of the second authentication method being higher than an authentication strength of the first authentication method.
